(19) United States
(12) Patent Application Publication
(10) Pub. No.: US 2012/0019874 A1
(43) Pub. Date: Jan. 26, 2012

(54) METHOD FOR DOCUMENT SCANNING

(76) Inventors: David M. Schaertel, Webster, NY (US); Daniel P. Phinney, Rochester, NY (US); George A. Hadgis, Spencerport, NY (US); Bruce A. Holroyd, Rochester, NY (US); Bruce A. Link, Rochester, NY (US); James A. Oliver, Webster, NY (US); Marybeth Schmidt, Rush, NY (US); Roland Simonis, Evanston, IL (US); Swapnil Sakharshete, Rochester, NY (US); Carl J. Tesavis, Spencerport, NY (US); Robert M. Westcott, Holley, NY (US); Donald C. Kurdt, Fairport, NY (US)

(21) Appl. No.: 12/839,476

(22) Filed: Jul. 20, 2010

(51) Int. Cl. H04N 1/04

(52) U.S. Cl. 358/474

(57) ABSTRACT

A method of determining document characteristics prior to processing the document in a document scanner (10) includes capturing an input image of documents in an input tray (20); transmitting the images to a processor (65); determining characteristics of the documents; and processing the document based on the characteristics.

### CROSS REFERENCE TO RELATED APPLICATIONS

Reference is made to commonly-assigned copending U.S. patent application Ser. No. ______ (Attorney Docket No. 96320/NAB), filed herewith, entitled A DOCUMENT SCANNER, by Schaertel et al.; the disclosure of which is incorporated herein.

### FIELD OF THE INVENTION

This invention relates to extracting properties of the document fed to a scanner from an input tray, before the document passes scanning cameras on a transport path.

### BACKGROUND OF THE INVENTION

A document scanner moves a document through a transport path and creates an image of the document as it moves. The processor memory for the document scanner must have preset document characteristics and the operator must select functions and features to accommodate the specific requirements for a particular document. Alternately, the scanner may default to less efficient settings that will process all documents since scanners are not typically programmed with specific requirements on a document-by-document basis.

The preset characteristics, features, and functions are a product of document characteristics, such as size, weight, texture, and specific application requirements such as resolution, imaging mode; for example color, simplex, or duplex. In a document scanner, the documents to be scanned may vary by size, weight, color content, physical condition, or other characteristics, which may require different scanner features to be enabled or operator actions to be employed, for the most optimal and efficient mode of operation. Prior knowledge of these many different document attributes can enable the proper selection of scanner features to improve the efficiency of the scanning process or enable other features which may provide specific applications required by a particular type, style, or size of document.

Prior knowledge of the documents physical condition can also prompt immediate action from the operator to protect the document or scanner or allow other features within the scanner to perform more reliably. There is a need, therefore, for detection of document characteristics prior to the document entering transport path.

### SUMMARY OF THE INVENTION

Briefly, according to one aspect of the present invention a method of determining document characteristics prior to processing the document in a document scanner includes capturing an input image of documents in an input tray; transmitting the images to a processor; determining characteristics of the documents; and processing the document based on the characteristics.

The invention and its objects and advantages will become more apparent in the detailed description of the preferred embodiment presented below.

### BRIEF DESCRIPTION OF THE DRAWINGS

FIG. 1 is a cross-section view from the side of a document scanner which illustrates the various parts of the scanner related to the present invention.

FIG. 2 is a perspective view of the scanner and illustrates various types of documents.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

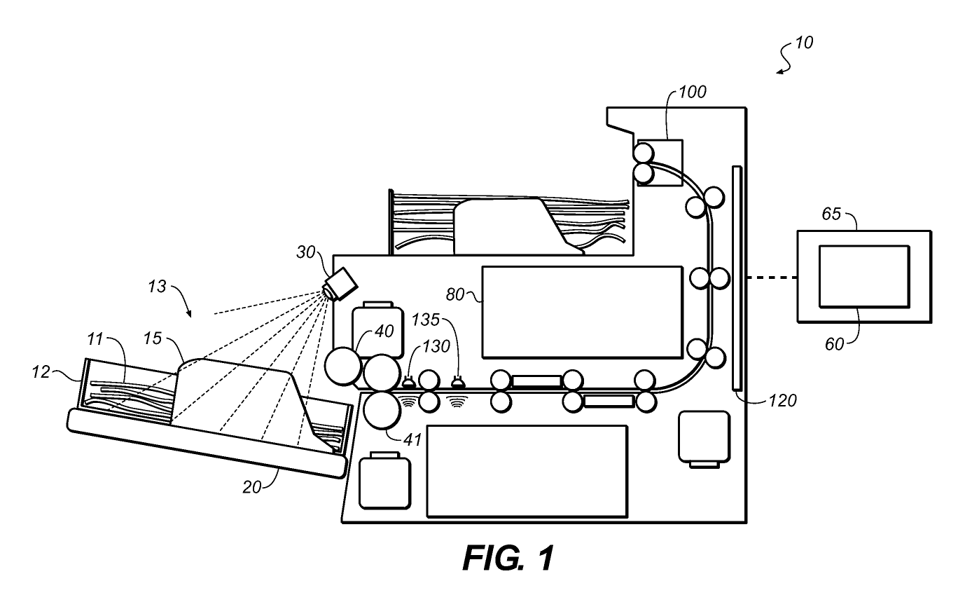

FIG. 1 is a side cross-sectional view of a document scanner 10. The illustration shows the input tray 20 and input tray camera or image capture device 30. A typical scanner also has a transport mechanism for moving documents through the scanner and an output tray for collecting documents as well as other components that makeup a document scanner.

As shown in FIG. 1, documents 11 are first placed in the input tray 20 of the scanner. Imaging capture device 30 captures an image of the top document on the stack of documents 11. The document image is captured both statically and dynamically as it begins to move forward into the scanner by the feed roller 40 and separation roller 41. As frames of image data are captured, they are transmitted to be processed by an image processor shown schematically as image processing block 60.

The image processing block 60 processes the image data, to determine document characteristics such as document content, document condition, the desired information to be extracted and saved from the document. These characteristics will enable a particular feature or operation of the scanner based on the document content or condition. The document is processed based on the document characteristics.

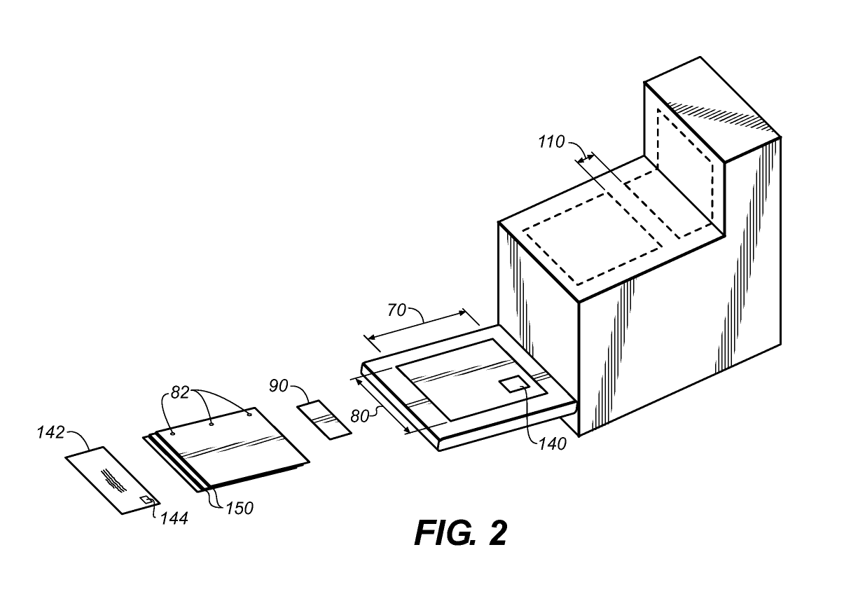

Some of the document characteristics that are important in processing the document is the document length 70 or width 80 shown in FIG. 2. If a short document is detected the master image buffer (not shown) size is reduced. If a short document is detected the feed roller 40 may also be stopped to prevent jams. For a longer document, the feed roller continues to run which will reduce feed roller wear.

Another scanner feature related to length and width includes sorting the document on exit from the scanner. For example, if the document is a check 90. The document may also be checked for compatibility with the scanner. Controlled output stacking 100 shown in FIG. 1 may be adjusted for higher throughput, or a document gap 110 may be adjusted according to document length.

An important document characteristic is orientation. Detection of the document orientation as portrait or landscape, relative to the direction of document travel, will be used to improve the performance of the auto orientation feature. Using document width or location of the document in the input tray 20, is used to improve the document locate function.

Color or lack thereof within a document will be determined to set the appropriate color mode for image capture. Stick on labels 140 are detected based on color. The results are used to disable ultrasonic sensing in the area of the label.

Content within the document will be used for line or form detection. This enables the processor 65 to determine whether to capture the image or not and what processing may be required for the image data if captured. Patches and barcodes will be detected and read for the processor to take the appropriate action. Detection of postage stamps 144 or envelopes 142 is used by the processor to adjust scanner operation.

Document content is processed using optical character recognition (OCR) to detect a predetermined word, detect and interpret magnetic character ink, photographs, text or graphics. The processor then modifies scanner functions, for example, disabling automatic orientation when no text is present. Money may also be detected and counted.

Document content is also used to detect checks 90 and document resolution. The processor uses this information to adjust scanner functions such as setting the image capture mode.

A document characteristic useful for scanner processing is a folded corner or torn portion of the document. If those defects are detected the transport will be stopped and the operator will be alerted to this condition. Holes 82 in the document will be detected by the input image capture device 30 and ignored by the machine control function 120 of the scanner. Wrinkles in the document, if detected, causes processor to optimized parameters for sonic 130 or ultrasonic 135 detection. Another detectable characteristic is a staple, paperclip, or rubber band on the document. When detected the processor stops the transport and the operator is alerted of the condition. Tape located on a document may be detected and is a possible indication of a fraudulent document.

Imaging of the input tray 20 area detects the presence of documents 11 or a batch box 12. Once documents are detected, the number of documents can be determined. The absence of documents in the input tray will be detected. Orientation or location of the documents detected indicates document skew and location. This information enhances the performance of automatic orientation. The transport may be stopped and the operator altered to conditions that adversely affect operation of the scanner.

Imaging of the documents 11 will be used to detect dual shadows 150 which may indicate a multi-feed. No movement of the documents may indicate a misfeed.

Imaging of the input area 13 and processing of the image data will determine characteristics of the input area whereby side guide 15 location can be determined. Correct side guide location will be determined with regard to the documents 11 in the input tray 20.

The invention has been described in detail with particular reference to certain preferred embodiments thereof, but it will be understood that variations and modifications can be effected within the scope of the invention.

### PARTS LIST

10 scanner
11 documents
12 batch box
13 input area
15 side guide
20 input tray
30 imaging capture device
40 feed roller
41 separation roller
60 image processing block
65 processor
70 document length
80 document width
82 holes
90 check
100 controlled output stacking
110 document gap
120 machine control function
130 sonic detection
135 ultrasonic detection
140 stick on label
142 envelope
144 postage stamp
150 dual shadows

1. A method of determining document characteristics prior to processing the document in a document scanner comprising:
capturing an input image of documents in an input tray;
transmitting said images to a processor;
determining characteristics of said documents; and
processing said document based on said characteristics.

2. The method of claim 1 wherein at least one characteristic is document length or width.

3. The method of claim 2 comprising:
reducing a master image buffer for short documents.

4. The method of claim 2 comprising:
stopping a feed roller on detection of short documents to reduce roller wear.

5. The method of claim 2 comprising:
modifying document processing on detection of a check.

6. The method claim 2 comprising:
checking document characteristics for compatibility with the scanner.

7. The method of claim 2 wherein dynamic controlled output stacking is based on document length.

8. The method of claim 2 comprising:
adjusting an inter-document gap according to document length.

9. The method of claim 1 wherein at least one characteristic is document color or tone.

10. The method claim 9 comprising:
detecting a post-it on the document based on color.

11. The method of claim 1 wherein at least one characteristic is document content.

12. The method of claim 11 wherein document content is used to provide form identification, line detection, image scan selection or scan or no scan.

13. The method of claim 11 wherein document content is used to detect or read a patch.

14. The method of claim 11 wherein document content is used to detect or read a barcode.

15. The method of claim 11 wherein document content is used to detect a postage stamp.

16. The method of claim 11 wherein document content is used to detect an envelope.

17. The method claim 11 wherein document content is used to detect a document thumbnail.

18. The method claim 11 wherein document content is processed using OCR to detect a predetermined word.

19. The method claim 11 wherein document content is used to detect photographs, text, or graphics.

20. The message out of claim 11 wherein document content is used to detect patches or pages.

21. The method of claim 11 wherein document content is used to detect the presence or absence of text.

22. The method of claim 21 comprising:
disabling automatic orientation if no text is present.

23. The method of claim 11 wherein document content is used to detect money.

24. The method of claim 23 wherein document content is used to count money.

25. The method of claim 11 wherein document content is used to detect checks.

26. The method of claim 11 wherein document content is used to detect document resolution characteristics such as color, grayscale, bitonal, or duplex documents.

27. The method of claim 26 comprising:
selecting a scanner mode based on the detected resolution.

28. The method of claim 1 wherein at least one characteristic is a folded corner.

29. The method of claim 1 wherein at least one characteristic is hole size in the document.

30. The method of claim 29 wherein the process ignores holes less than or greater than a predetermined size.

31. The method of claim 1 wherein at least one characteristic is paper tears.

32. The document scanner as in claim 1 wherein at least one characteristic is a wrinkle in the document.

33. The method of claim 32 comprising:
optimizing ultrasonic parameters on detection of a wrinkle

34. The method of claim 32 comprising:
optimizing sonic jam detection parameters on detection of a wrinkle.

35. The method of claim 1 wherein said characteristic are selected from a group comprising a staple, paperclip, or rubber band.

36. The method of claim 1 wherein at least one characteristic is presence of the document.

37. The method of claim 1 wherein at least one characteristic is presence of a batch box.

38. The method of claim 1 wherein at least one characteristic is number of documents in the input tray.

39. The method of claim 1 wherein at least one characteristic is absence sense of documents in the input tray.
